(19) United States
(12) Patent Application Publication
(10) Pub. No.: US 2012/0254450 A1
(43) Pub. Date: Oct. 4, 2012

(54) TIERED HIERARCHICAL REMOTE USER INTERFACE

(75) Inventors: Stephane Lejeune, San Diego, CA (US); Graham Clift, El Cajon, CA (US)

(73) Assignee: SONY CORPORATION, Tokyo (JP)

(21) Appl. No.: 13/073,697

(22) Filed: Mar. 28, 2011

(51) Int. Cl. G06F 15/16; G06F 3/14

(52) U.S. Cl. 709/228; 709/203

(57) ABSTRACT

A method of structuring Remote User Interface (RUI) into a tiered hierarchical standard with a minimum base RUI profile that is supported by all devices that meet the standard with optional support for the higher level hierarchies within the tier. RUI profiles are a superset of a lower RUI, so that lower RUIs are able to be partially rendered by a higher RUI.

### FIELD OF THE INVENTION

The present invention relates to the field of user interfaces. More specifically, the present invention relates to a tiered hierarchical Remote User Interface (Remote UI or RUI).

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resources and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. DLNA also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderers screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

Therefore, of these options described, none is optimal.

### SUMMARY OF THE INVENTION

A method of structuring Remote User Interface (RUI) into a tiered hierarchical standard with a minimum base RUI profile that is supported by all devices that meet the standard with optional support for the higher level hierarchies within the tier. RUI profiles are a superset of a lower RUI, so that lower RUIs are able to be partially rendered by a higher RUI.

In one aspect, a method of implementing a tiered hierarchical remote user interface comprises discovering a first device by a second device, determining possible remote user interface protocols by discovering properties of the first device and establishing a remote user interface session between the first device and the second device by selecting a common supported protocol of the remote user interface protocols. The method further comprises partially rendering by the second device to the common protocol selected and delivering rendered output to the first device. The common supported protocol is selected from a group of tiered protocols including a common base protocol. The first device is a target device and the second device is an application device. Discovering occurs by Universal Plug and Play. The common supported protocol comprises a highest level common supported protocol. The common supported protocol is intelligently determined based on one or more factors. The one or more factors include a server load, available server memory, client load and available client memory, application requirements and overall network load. The second device advertises only the profile currently supported based on a current load of the second device. A server requests the first device and the second device to transition to a higher protocol in order to free up workload. The first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a system programmed in a controller in a device comprises a discovering module for discovering a device, a determining module for determining properties including a protocol of the device and a protocol selection module for selecting the protocol. The protocol selection module establishes a remote user interface session between the system and the device. The controller is selected from the group consisting of a programmed computer readable medium and an application-specific circuit.

In another aspect, a network of devices comprises a server device and a client device, wherein the server device and the client device each implement a common remote user interface protocol selected from a tiered set of protocols. The tiered set of protocols includes at least a base protocol. Every device implementing Universal Plug and Play includes at least the base protocol. Each tier of the tiered set of protocols is a superset of a previous tier.

In yet another aspect, a server device comprises a memory for storing an application, the application for discovering a client device, determining possible remote user interface protocols by discovering properties of the client device and establishing a session between the client device and the server device by selecting a common supported protocol of the remote user interface protocols and a processing component coupled to the memory, the processing component configured for processing the application. The common supported protocol is selected from a group of tiered protocols including a common base protocol. Discovering occurs by Universal Plug and Play. The common supported protocol comprises a highest level common supported protocol. The common supported protocol is intelligently determined based on one or more factors. The one or more factors include a server load, available server memory, client load and available client memory, application requirements and overall network load.

In another aspect, a client device comprises a memory for storing an application, the application for providing a remote user interface protocol to a server device, communicating with the server device using the remote user interface protocol and a processing component coupled to the memory, the processing component configured for processing the application. The remote user interface protocol is selected from a group of tiered protocols. The remote user interface protocol is a common supported protocol selected from a group of tiered protocols including a common base protocol. The server device discovers the client device by Universal Plug and Play.

In yet another aspect, a device comprises a memory for storing an application, the application for processing a tiered hierarchical remote user interface comprising a base profile and at least an additional profile which is an extension of the base profile and a processing component coupled to the memory, the processing component configured for processing the application. The device is discovered by Universal Plug and Play. The device determines which profile to use intelligently based on one or more factors. The one or more factors include a server load, available server memory, client load and available client memory, application requirements and overall network load.

### BRIEF DESCRIPTION OF THE DRAWINGS

FIG. 1 illustrates a block diagram of exemplary tiers of different graphical and video remote user interfaces according to some embodiments.

FIG. 2 illustrates a flowchart of a method of utilizing the tiered hierarchical RUI according to some embodiments.

FIG. 3 illustrates a network of devices utilizing the tiered hierarchical RUI according to some embodiments.

FIG. 4 illustrates a block diagram of a server device and a client device implementing the tiered hierarchical RUI according to some embodiments.

FIG. 5 illustrates a block diagram of an exemplary computing device configured to implement the method of utilizing the tiered hierarchical remote user interface according to some embodiments.

### DETAILED DESCRIPTION OF THE PREFERRED EMBODIMENT

In order to assess the usability of any remote user interface, the requirements on network and processor performances, memory availability on servers and clients, operating systems, middleware and application frameworks, types of applications and the likely network distribution are considered. In doing so, a design that satisfies the maximum number of scenarios arises through a novel tiered hierarchical Remote User Interface (RUI) framework that uses a base profile that all compatible devices implement. Upper layers in the hierarchy are able to be partially rendered down to the base profile RUI or make use of a higher level RUI protocol when compatible devices determine using a novel decision tree that the distribution of performances between clients, servers as well as the network load justifies it.

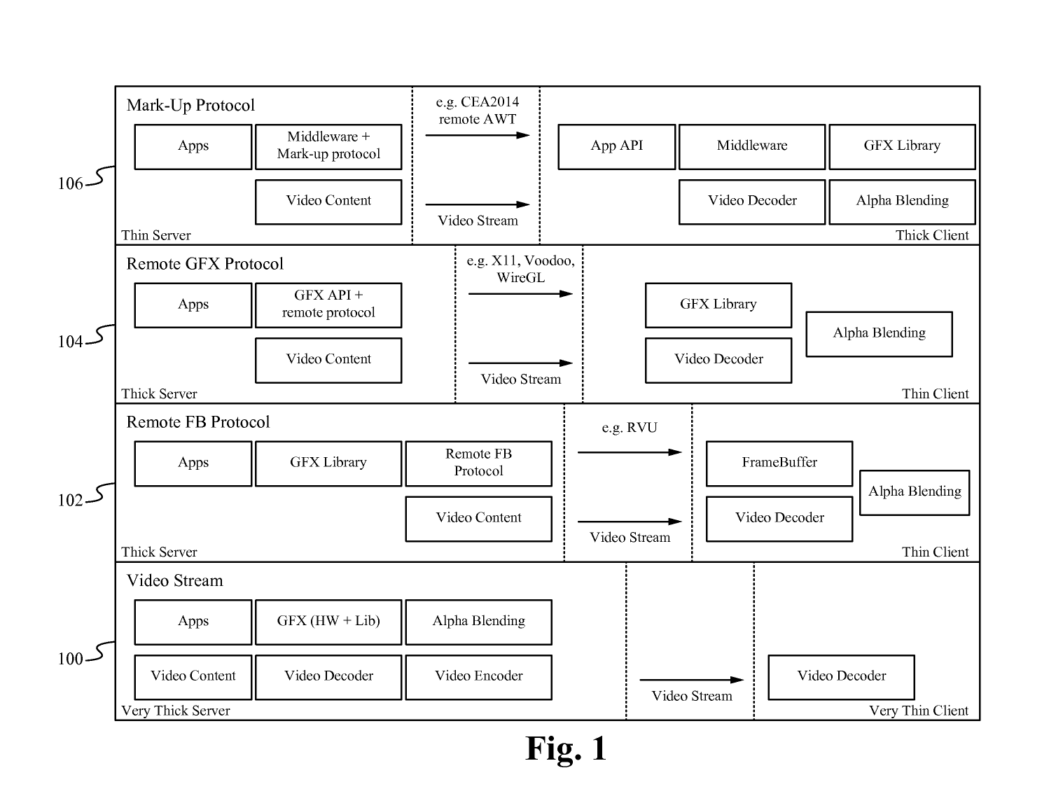

FIG. 1 illustrates a block diagram of exemplary tiers of different graphical and video remote user interfaces according to some embodiments. At a bottom (base) tier 100, graphics are encapsulated into the video stream, requiring no further protocol on the client beyond UPnP and video decoding but requiring a real time very heavy load on the server to decode video, blend in the graphics and then re-encode the video onto a stream. For this system to also be responsive to user inputs the latency should be low, placing an even greater requirement on the server processor performance.

Next up the table, a second tier 102, the remote framebuffer approaches such as RVU and VNC are shown, which work by generating and manipulating the pixels stored in the on-screen and off-screen buffers on the client side. Commands are simple, making no assumptions about the potential advanced graphics capabilities of many modern graphics processors and graphics libraries beyond being able to assign an area of memory for buffering pixel data, and for the graphics processor to cut, stretch and blend rectangular regions of buffered pixel data onto the displayable layers. In this case, the server should be able to carry the graphics library and perform most of the pixel placement calculations, and so again, this is a thick server and lightweight client from the memory perspective. However, since even simple single-colored rectangular blocks are only seen as pixel data by the protocol, there is a heavy load on the network resources on both the server, client and bandwidth usage.

Next up, a third tier 104, uses a remote GFX protocol. An example very familiar to UNIX and Linux PC environments is the X window system, and in particular, the X11 protocol. Other similar examples are remote DirectFB protocol (voodoo) and remote OpenGL protocol (WireGL). The basis behind these protocols is to transfer commands across the network at a hardware independent graphics API level. The exact implementation therefore depends on the particular API, so each protocol is a little different. The advantage to this method is that draw commands and text commands as well as 3D rotations and animations are able to be performed without the need to send large quantities of pixel data across the network. This does however place more processing and memory load on the client side, but removes the need to have full graphics library implemented or the memory to store the generated pixel data on the server side.

At the top, a fourth tier 106, is a User Interface protocol. Examples include CE-2014, remote Java AWT or even exporting the UI components of an application. This protocol implements the execution of an additional application framework on top of the graphics library and includes interpreters such as browsers and Java VM's. These produce thin servers but thick clients. User Interface protocols are sent as data and presentation files for the clients to interpret within an application framework, generating graphics commands and then ultimately blending and rendering with the video stream by the graphics hardware. Although four tiers are described herein, any number of tiers are able to be implemented. Furthermore, the specific implementations of each of the tiers are able to be any implementation and are not limited to the examples described herein. Additionally, any tier is able to be a base tier as long as the additional tiers build upon the base tier. For example, the framebuffer approach is able to be a base tier with additional tiers above it.

### Basic Implementation

With a basic hierarchy of protocols, the optimal implementation of RUI to satisfy as many client and server environments as possible is considered. Within the range of currently common processing elements used in consumer electronics, the video stream approach is untenable due to latency requirements of the UI responsiveness and additional hardware requirements for the server. However at the framebuffer protocol level, all clients support or are able to support some form of framebuffer approach since all ultimately adopt pixel manipulation of the layer for rendering graphics. A base profile is able to be selected based upon a framebuffer protocol and allowed to be supported by all clients. In addition, if the server has the memory available to support the framebuffer protocol and the performance of its user interface is acceptable over this protocol, then it too should support this to maximize the possible set of rendering clients. However it is possible that both, the client and server support a similar graphics library. Through UPnP discovery methods, the client and server are able to negotiate to use a higher tiered protocol thus shifting some of the processing load from the server to the client. This makes sense, for instance, if the server is trying to support multiple clients simultaneously or the network is heavily loaded, or the client supports accelerated graphics and thus is able to support additional processing without slowing down.

In the basic implementation, a higher tiered protocol is assumed to be better since if the renderer could not handle the extra processing then it would not have been designed to support this RUI in the first place. Also, all servers support the base profile, but allowing progression in technology to advance the base profile specification to incorporate further sets of graphics operations is an important aspect. In this way, servers that are released and designed to work at a base profile 2 will also work with base profile 1 client albeit with downgraded performance. One particularly appealing benefit of this tiered approach is for a manufacturer to “brand” a higher profile and design their devices to cooperate with top performance in mind, and yet allow for a fallback position to support other devices when needed for whole home compatibility. This also allows manufacturers to maintain intellectual property associated with an internally developed higher tier protocol, and yet maintain an open compatibility platform through the base profile.

### Advanced Implementations

There are able to be instances where selection of the highest tiered protocol is not the optimal choice. Server load, available server memory, client load and available client memory, application requirements and overall network load are able to be influencing factors on which protocol would be optimal. An intelligent implementation choice analyzes some or all of these parameters and switches to the optimal protocol accordingly. In another implementation choice, the device is able to choose to advertise only the profile it currently is able to support based on its current load. In yet another implementation, a server is able to request its clients to transition to a higher protocol in order to free up some workload (for example, in order to accommodate an additional client).

In addition it might be that more than one RUI protocol is able to be utilized concurrently to render parts of the applications in different ways. This might be especially useful when a plug-in to a browser, for instance, is not supported by the client, despite the fact that the basic browser RUI is. In this case the plug-in is able to be delivered using the framebuffer protocol and blended within a region of the browser UI. This would be similar to how a video stream has its own network delivery protocol but is ultimately displayed within or blended with other graphics layers.

There are able to be cases when both servers and clients are required to be very light weight, for instance in cost sensitive devices or multiple client rendering. In this case, an external networked partial rendering adapter is able to be used to perform higher to lower tier translation. For example, the adapter described in U.S. patent application No. Atty. Docket No. Sony-39800, filed ______, entitled REMOTE USER INTERFACE ADAPTER, which is incorporated by reference herein. A thin server on a home network is able to provide a RUI to multiple thin clients by building this partial rendering adapter into a high powered network bridge. The bridge provides all the access to the multiple thin clients, but isolates the rest of the home from the bandwidth implications of using a low tier protocol. This keeps the costs of the client down, the cost of the server down and maintains low amounts of traffic on the home network.

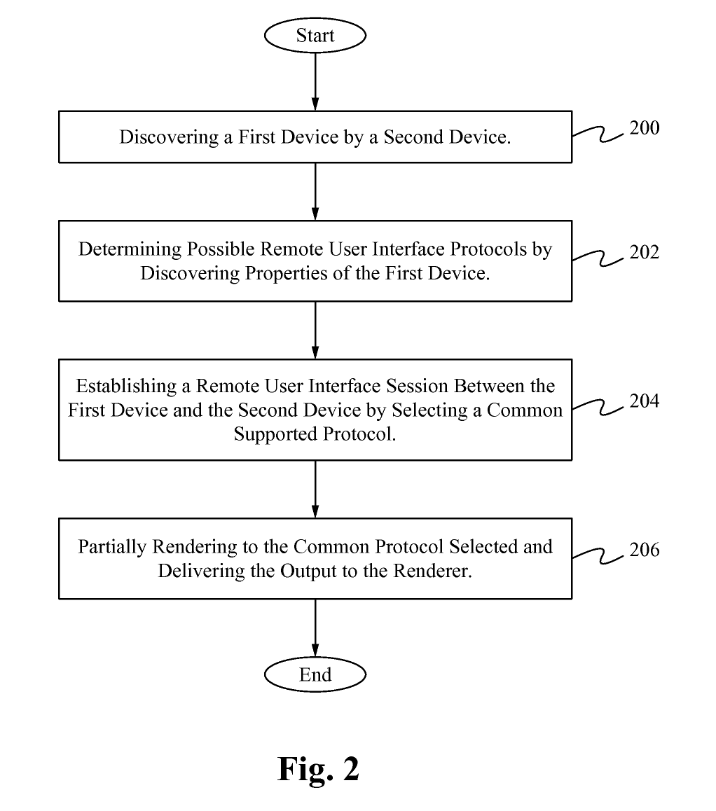

FIG. 2 illustrates a flowchart of a method of utilizing tiered hierarchical remote user interface according to some embodiments. In the step 200, a target device is discovered by an application device. For example, an application device discovers a target remote renderer by extended UPnP or other discovery mechanism. In some embodiments, the target device is known by the application device, and the step 200 is able to be skipped. In the step 202, properties discovered about the renderer are analyzed by the application device, and all possible RUI protocols are determined. In the step 204, the highest level common supported protocol is selected and a session is established with the renderer. In some embodiments, instead of utilizing the highest level common supported protocol, the protocol is intelligently determined based on factors such as network resources and device resources. In the step 206, the application device partially renders, if necessary, to the common protocol selected and delivers the output to the renderer. This is able to be an extension to the UPnP device control protocol. Although specific steps are described, in some embodiments, fewer or more steps are included, and/or the order of the steps is able to be changed.

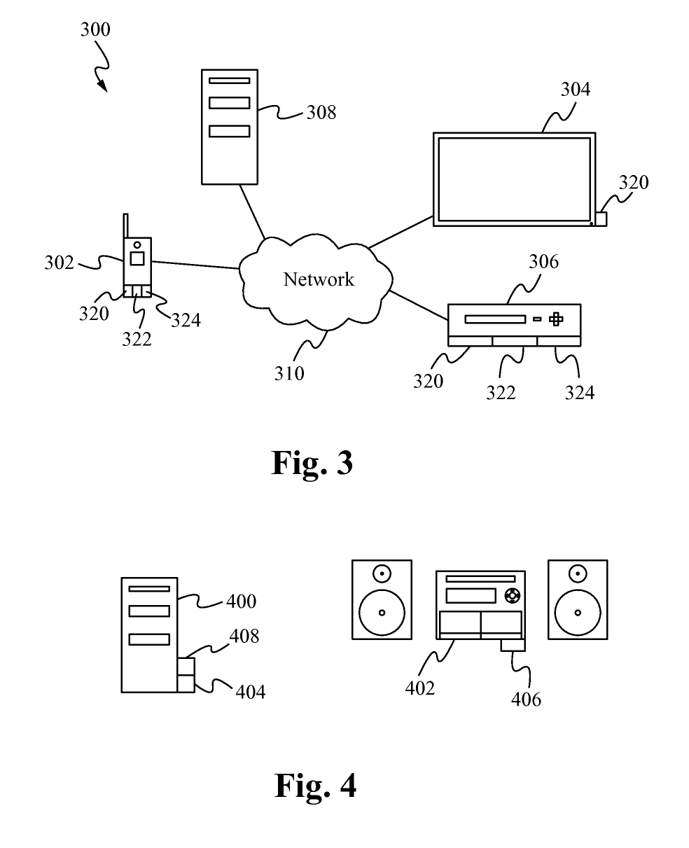

FIG. 3 illustrates a network of devices 300 utilizing the tiered hierarchical RUI according to some embodiments. A first device 302, a second device 304, a third device 306 and a server 308 are operatively coupled through a network 310. The devices are also able to be directly coupled, for example, the first device 302 is able to be directly coupled to the second device 304 and the third device 306.

The first device 302 (e.g. mobile phone) implements a third tier profile 324 which includes a second tier profile 322 and a base profile 320. The second device 304 (e.g. television) implements the base profile 320 only. The third device 306 (e.g. a Blu-ray® Player) implements the third tier profile 324 including the sub-profiles: the second tier profile 322 and the base profile 320. Therefore, when utilizing the RUI with the first device 302 to operate with the second device 304, only the base profile 320 is utilized since that is the only common profile on each of the devices. However, when utilizing the RUI with the first device 302 to operate the third device 306, the third tier profile 324 is utilized since it is the highest level profile common to both devices. If an advanced implementation is utilized (e.g. intelligent load analysis), the first device 302 and the third device 306 are able to select among the base tier profile 320, the second tier profile 322 and the third tier profile 324 depending on network conditions.

The server 308 is able to be any computing device capable of storing and serving data such as a standard server. The information stored on the server 308 includes any information useful for facilitating communications between the devices. Furthermore, the server 308 is able to be one or more servers which are able to act jointly or independently of each other.

The network 310 is able to be any type of network such as a Local Area Network (LAN), a Wide Area Network (WAN), the Internet, a network of networks or any other network. Additionally, the type of network is able to be wireless, wired, cellular, any other type of network or any combination of two or more networks. In some embodiments, a network is not used and devices are directly coupled. Although the network of devices shown includes three devices, any number of devices is possible.

FIG. 4 illustrates a block diagram of a server device 400 and a client device 402 according to some embodiments. The server device (e.g. server) 400 implements a four tier profile 404 including three sub-tiers. The client device (e.g. stereo) 402 implements a two tier profile 406 including the base tier. The server device 400 discovers the client device 402 and determines the profiles implemented on the client device 402. An intelligent profile selection 408 is implemented to determine which profile to utilize. The profile selection is able to be based on aspects such as server load, available server memory, client load and available client memory, application requirements and overall network load. Since the server device 400 and the client device 402 have in common the base tier profile and the second tier profile, they are able to select which one to utilize. The server device 400 and the client device 402 are able to communicate with each other utilizing the profiles. For example, the server device 400 is able to remotely control the client device 402.

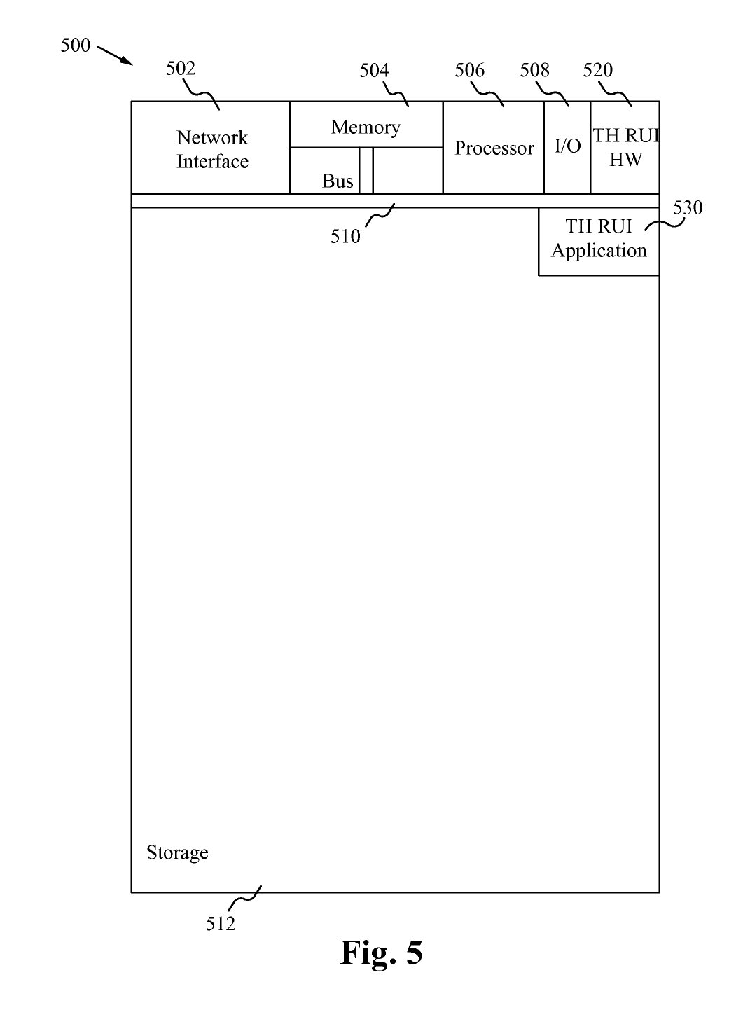

FIG. 5 illustrates a block diagram of an exemplary computing device 500 configured to implement any aspect of the tiered hierarchical remote user interfaces according to some embodiments. The computing device 500 is able to be used to acquire, store, compute, communicate and/or display information. For example, the computing device 500 is able to acquire, store and implement one or more profiles. In another example, the computing device 500 is a thin client or a thick client. Although these examples have been listed, the computing device 500 is able to be configured to implement the any aspect of the methods described herein. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, Blu-ray®, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. Tiered hierarchical remote user interface application(s) 530 used to perform the tiered hierarchical remote user interface method are likely to be stored in the storage device 512 and memory 504 and processed as applications are typically processed. More or less components shown in FIG. 5 are able to be included in the computing device 500. In some embodiments, tiered hierarchical remote user interface hardware 520 is included. Although the computing device 500 in FIG. 5 includes applications 530 and hardware 520, the tiered hierarchical remote user interface method is able to be implemented on a computing device in hardware, firmware, software or any combination thereof. For example, in some embodiments, the tiered hierarchical remote user interface applications 530 are programmed in a memory and executed using a processor. In another example, in some embodiments, the tiered hierarchical remote user interface hardware 520 is programmed hardware logic including gates specifically designed to implement the tiered hierarchical remote user interface method.

In some embodiments, the tiered hierarchical remote user interface application(s) 530 include several applications and/or modules. As described herein, a discovering module is for discovering another device, a determining module is for determining properties of the device and a protocol selection module is for selecting a protocol. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

To utilize the tiered hierarchical RUI, devices determine a profile of a device to be communicated with. If the devices implement the same upper level profile, then they are able to take advantage of the features in that profile. If the devices do not implement the same upper level profile, at a minimum, they will implement a base profile. An intelligent profile selector is able to determine which profile to utilize if the devices are able to implement multiple profiles.

In operation, the tiered hierarchical RUI supports two or more remote user interfaces, where a first remote user interface is a base profile and at least a second profile is a higher tiered remote user interface. Higher tiers are generally defined as placing a greater rendering load on the client and lesser load on the server and network. All supported profiles are revealed during the UPnP discovery process. Clients and servers establish RUI connections by selecting the highest tier commonly supported protocol available.

### Some Embodiments of Tiered Hierarchical Remote User Interface

1. A method of implementing a tiered hierarchical remote user interface comprising:
   a. discovering a first device by a second device;
   b. determining possible remote user interface protocols by discovering properties of the first device; and
   c. establishing a remote user interface session between the first device and the second device by selecting a common supported protocol of the remote user interface protocols.
2. The method of clause 1 further comprising partially rendering by the second device to the common protocol selected and delivering rendered output to the first device.
3. The method of clause 1 wherein the common supported protocol is selected from a group of tiered protocols including a common base protocol.
4. The method of clause 1 wherein the first device is a target device and the second device is an application device.
5. The method of clause 1 wherein discovering occurs by Universal Plug and Play.
6. The method of clause 1 wherein the common supported protocol comprises a highest level common supported protocol.
7. The method of clause 1 wherein the common supported protocol is intelligently determined based on one or more factors.
8. The method of clause 7 wherein the one or more factors include a server load, available server memory, client load and available client memory, application requirements and overall network load.
9. The method of clause 1 wherein the second device advertises only the profile currently supported based on a current load of the second device.
10. The method of clause 1 wherein a server requests the first device and the second device to transition to a higher protocol in order to free up workload.
11. The method of clause 1 wherein the first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
12. A system programmed in a controller in a device comprising:
   a. a discovering module for discovering a device;
   b. a determining module for determining properties including a protocol of the device; and
   c. a protocol selection module for selecting the protocol.
13. The system of clause 12 wherein the protocol selection module establishes a remote user interface session between the system and the device.
14. The system of clause 12 wherein the controller is selected from the group consisting of a programmed computer readable medium and an application-specific circuit.
15. A network of devices comprising:
   a. a server device; and
   b. a client device, wherein the server device and the client device each implement a common remote user interface protocol selected from a tiered set of protocols.
16. The network of devices of clause 15 wherein the tiered set of protocols includes at least a base protocol.
17. The network of devices of clause 16 wherein every device implementing Universal Plug and Play includes at least the base protocol.
18. The network of devices of clause 15 wherein each tier of the tiered set of protocols is a superset of a previous tier.
19. A server device comprising:
   a. a memory for storing an application, the application for:
      i. discovering a client device;
      ii. determining possible remote user interface protocols by discovering properties of the client device; and
      iii. establishing a session between the client device and the server device by selecting a common supported protocol of the remote user interface protocols; and
   b. a processing component coupled to the memory, the processing component configured for processing the application.
20. The server device of clause 19 wherein the common supported protocol is selected from a group of tiered protocols including a common base protocol.
21. The server device of clause 19 wherein discovering occurs by Universal Plug and Play.
22. The server device of clause 19 wherein the common supported protocol comprises a highest level common supported protocol.
23. The server device of clause 19 wherein the common supported protocol is intelligently determined based on one or more factors.
24. The server device of clause 23 wherein the one or more factors include a server load, available server memory, client load and available client memory, application requirements and overall network load.
25. A client device comprising:
   a. a memory for storing an application, the application for:
      i. providing a remote user interface protocol to a server device; and
      ii. communicating with the server device using the remote user interface protocol; and
   b. a processing component coupled to the memory, the processing component configured for processing the application.
26. The client device of clause 25 wherein the remote user interface protocol is selected from a group of tiered protocols.
27. The client device of clause 25 wherein the remote user interface protocol is a common supported protocol selected from a group of tiered protocols including a common base protocol.
28. The client device of clause 25 wherein the server device discovers the client device by Universal Plug and Play.
29. A device comprising:
   a. a memory for storing an application, the application for processing a tiered hierarchical remote user interface comprising:
      i. a base profile; and
      ii. at least an additional profile which is an extension of the base profile; and
   b. a processing component coupled to the memory, the processing component configured for processing the application.
30. The device of clause 29 wherein the device is discovered by Universal Plug and Play.
31. The device of clause 29 wherein the device determines which profile to use intelligently based on one or more factors.
32. The device of clause 31 wherein the one or more factors include a server load, available server memory, client load and available client memory, application requirements and overall network load.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing a tiered hierarchical remote user interface comprising:
a. discovering a first device by a second device;
b. determining possible remote user interface protocols by discovering properties of the first device; and
c. establishing a remote user interface session between the first device and the second device by selecting a common supported protocol of the remote user interface protocols.

2. The method of claim 1 further comprising partially rendering by the second device to the common protocol selected and delivering rendered output to the first device.

3. The method of claim 1 wherein the common supported protocol is selected from a group of tiered protocols including a common base protocol.

4. The method of claim 1 wherein the first device is a target device and the second device is an application device.

5. The method of claim 1 wherein discovering occurs by Universal Plug and Play.

6. The method of claim 1 wherein the common supported protocol comprises a highest level common supported protocol.

7. The method of claim 1 wherein the common supported protocol is intelligently determined based on one or more factors.

8. The method of claim 7 wherein the one or more factors include a server load, available server memory, client load and available client memory, application requirements and overall network load.

9. The method of claim 1 wherein the second device advertises only the profile currently supported based on a current load of the second device.

10. The method of claim 1 wherein a server requests the first device and the second device to transition to a higher protocol in order to free up workload.

11. The method of claim 1 wherein the first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

12. A system programmed in a controller in a device comprising:
a. a discovering module for discovering a device;
b. a determining module for determining properties including a protocol of the device; and
c. a protocol selection module for selecting the protocol.

13. The system of claim 12 wherein the protocol selection module establishes a remote user interface session between the system and the device.

14. The system of claim 12 wherein the controller is selected from the group consisting of a programmed computer readable medium and an application-specific circuit.

15. A network of devices comprising:
a. a server device; and
b. a client device, wherein the server device and the client device each implement a common remote user interface protocol selected from a tiered set of protocols.

16. The network of devices of claim 15 wherein the tiered set of protocols includes at least a base protocol.

17. The network of devices of claim 16 wherein every device implementing Universal Plug and Play includes at least the base protocol.

18. The network of devices of claim 15 wherein each tier of the tiered set of protocols is a superset of a previous tier.

19. A server device comprising:
a. a memory for storing an application, the application for:
i. discovering a client device;
ii. determining possible remote user interface protocols by discovering properties of the client device; and
iii. establishing a session between the client device and the server device by selecting a common supported protocol of the remote user interface protocols; and
b. a processing component coupled to the memory, the processing component configured for processing the application.

20. The server device of claim 19 wherein the common supported protocol is selected from a group of tiered protocols including a common base protocol.

21. The server device of claim 19 wherein discovering occurs by Universal Plug and Play.

22. The server device of claim 19 wherein the common supported protocol comprises a highest level common supported protocol.

23. The server device of claim 19 wherein the common supported protocol is intelligently determined based on one or more factors.

24. The server device of claim 23 wherein the one or more factors include a server load, available server memory, client load and available client memory, application requirements and overall network load.

25. A client device comprising:
a. a memory for storing an application, the application for:
i. providing a remote user interface protocol to a server device; and
ii. communicating with the server device using the remote user interface protocol; and
b. a processing component coupled to the memory, the processing component configured for processing the application.

26. The client device of claim 25 wherein the remote user interface protocol is selected from a group of tiered protocols.

27. The client device of claim 25 wherein the remote user interface protocol is a common supported protocol selected from a group of tiered protocols including a common base protocol.

28. The client device of claim 25 wherein the server device discovers the client device by Universal Plug and Play.

29. A device comprising:
a. a memory for storing an application, the application for processing a tiered hierarchical remote user interface comprising:
i. a base profile; and
ii. at least an additional profile which is an extension of the base profile; and
b. a processing component coupled to the memory, the processing component configured for processing the application.

30. The device of claim 29 wherein the device is discovered by Universal Plug and Play.

31. The device of claim 29 wherein the device determines which profile to use intelligently based on one or more factors.

32. The device of claim 31 wherein the one or more factors include a server load, available server memory, client load and available client memory, application requirements and overall network load.
